(19) United States
(12) Patent Application Publication
(10) Pub. No.: US 2026/0171001 A1
(43) Pub. Date: Jun. 18, 2026

(54) DISPLAY DEVICE AND ELECTRONIC DEVICE

(71) Applicant: Samsung Display Co., Ltd., Yongin-si (KR)

(72) Inventors: Sun Joon HWANG, Yongin-si (KR); Bo Ram SHIN, Yongin-si (KR); Yun Seong KIM, Yongin-si (KR); Sang Wook PARK, Yongin-si (KR); Jung Deok SEO, Yongin-si (KR)

(21) Appl. No.: 19/238,270

(22) Filed: Jun. 13, 2025

(30) Foreign Application Priority Data
Dec. 13, 2024 (KR) 10-2024-0186084

(51) Int. Cl. G09G 3/32; G09G 3/3291

(52) U.S. Cl. CPC G09G 3/32; G09G 3/3291; G09G 2310/0275; G09G 2320/0247; G09G 2320/0271; G09G 2330/021; G09G 2330/028; G09G 2360/16

(57) ABSTRACT

A display device includes a pixel unit including pixels connected to data lines, a data driver configured to selectively apply a data voltage and a park voltage to the data lines, a voltage provider configured to provide the park voltage, and a park voltage determiner configured to determine the park voltage based on grayscales for the pixels.

### CROSS-REFERENCE TO RELATED APPLICATION

The present application claims priority to, and the benefit of, Korean Patent Application No. 10-2024-0186084, filed on Dec. 13, 2024, in the Korean Intellectual Property Office, the disclosure of which is incorporated herein by reference.

### BACKGROUND

### 1. Field

The present disclosure relates to a display device and an electronic device.

### 2. Description of the Related Art

With the development of information technology, the importance of a display device, which is a connection medium between a user and information, is being highlighted. Accordingly, the use of display devices, such as a liquid crystal display device and an organic light-emitting display device is increasing.

The display device may include a data driver that provides data voltages to data lines, and pixels that display an image. The pixels record the data voltages received through the data lines, and display an image based on the data voltage.

There may be a question of which voltage to apply to the data line during a period in which data voltages are not provided. A tradeoff relationship between power consumption and image quality may be considered.

### SUMMARY

An aspect provides a display device and an electronic device capable of maintaining high image quality while reducing power consumption.

A display device according to one or more embodiments includes a pixel unit including pixels connected to data lines, a data driver configured to selectively apply a data voltage and a park voltage to the data lines, a voltage provider configured to provide the park voltage, and a park voltage determiner configured to determine the park voltage based on grayscales for the pixels.

The display device may be configured to display an image at a first frequency in a first mode, and at a second frequency in a second mode, wherein the park voltage includes a first park voltage to be provided to the data lines in the first mode for a first period.

The park voltage may include a second park voltage to be provided to the data lines in the second mode for a second period.

The second frequency may be less than the first frequency, wherein the second period is longer than the first period.

The park voltage determiner may include a target area setter configured to set a part of the pixel unit as a target area.

The park voltage determiner may further include a first histogram calculator configured to calculate a first histogram of a distribution of data voltages of the target area.

The park voltage determiner may further include a representative data voltage calculator configured to calculate a representative data voltage based on weights, the first histogram, and the data voltages of the target area, and a first park voltage determiner configured to determine the first park voltage based on the representative data voltage.

The park voltage determiner may further include a second histogram calculator configured to calculate a second histogram for a distribution of data voltages of an entire area of the pixel unit.

The park voltage determiner may further include a flicker value calculator configured to calculate second flicker values based on the second histogram and first flicker values.

The park voltage determiner may further include a second park voltage determiner configured to determine the second park voltage based on a minimum value among the second flicker values.

An electronic device according to one or more embodiments includes a processor configured to provide image data, and a display device configured to display an image based on grayscales of the image data, and including a pixel unit including pixels connected to data lines, a data driver configured to selectively apply a data voltage and a park voltage to the data lines, a voltage provider configured to provide the park voltage, and a park voltage determiner configured to determine the park voltage based on the grayscales for the pixels.

The display device may be configured to display the image at a first frequency in a first mode, and at a second frequency in a second mode, wherein the park voltage includes a first park voltage to be provided to the data lines in the first mode for a first period.

The park voltage may include a second park voltage to be provided to the data lines in the second mode for a second period.

The second frequency may be less than the first frequency, wherein the second period is longer than the first period.

The park voltage determiner may include a target area setter configured to set a part of the pixel unit as a target area.

The park voltage determiner may further include a first histogram calculator configured to calculate a first histogram of a distribution of data voltages of the target area.

The park voltage determiner may further include a representative data voltage calculator configured to calculate a representative data voltage based on weights, the first histogram, and the data voltages of the target area, and a first park voltage determiner configured to determine the first park voltage based on the representative data voltage.

The park voltage determiner may further include a second histogram calculator configured to calculate a second histogram for a distribution of data voltages of an entire area of the pixel unit.

The park voltage determiner may further include a flicker value calculator configured to calculate second flicker values based on the second histogram and first flicker values.

The park voltage determiner may further include a second park voltage determiner configured to determine the second park voltage based on a minimum value among the second flicker values.

### BRIEF DESCRIPTION OF THE DRAWINGS

The above and other aspects of the disclosure will become more apparent by describing in further detail embodiments thereof with reference to the accompanying drawings, in which:

FIG. 1 is a diagram illustrating a display device according to one or more embodiments of the present disclosure.

FIG. 2 is a diagram illustrating a pixel according to one or more embodiments of the present disclosure.

FIGS. 3 to 6 are diagrams for describing a change in a display frequency according to one or more embodiments of the present disclosure.

FIG. 7 is a diagram illustrating an address scan period according to one or more embodiments of the present disclosure.

FIG. 8 is a diagram illustrating a self-scan period according to one or more embodiments of the present disclosure.

FIG. 9 is a diagram illustrating an auxiliary scan period according to one or more embodiments of the present disclosure.

FIG. 10 is a diagram for describing a mode and a park voltage of a display device according to one or more embodiments of the present disclosure.

FIG. 11 is a diagram illustrating a park voltage determiner according to one or more embodiments of the present disclosure.

FIGS. 12 to 16 are diagrams for describing a process in which the park voltage determiner determines the first park voltage.

FIGS. 17 to 22 are diagrams for describing a process in which the park voltage determiner determines the second park voltage.

FIG. 23 is a block diagram of an electronic device according to one or more embodiments.

FIGS. 24 to 26 are schematic diagrams of an electronic device according to various embodiments.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

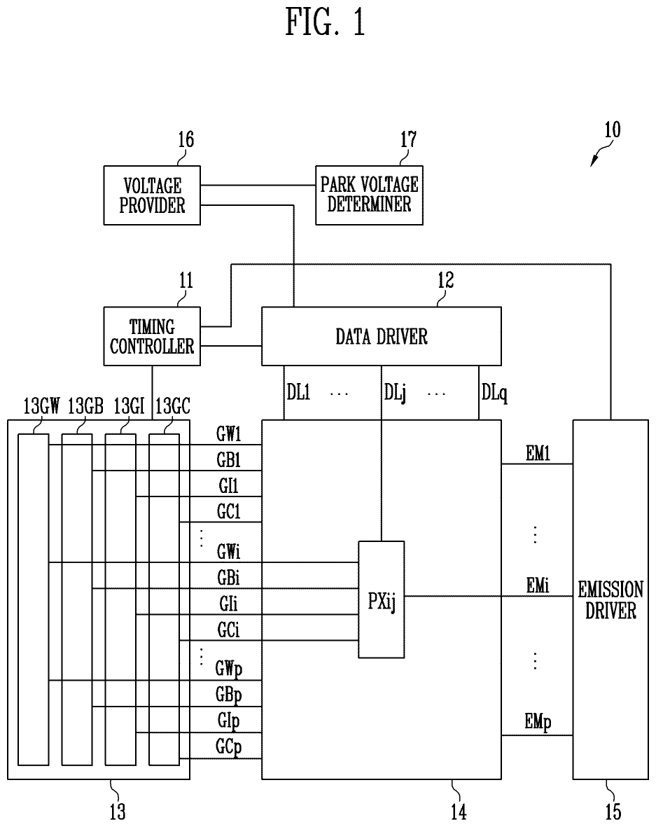

FIG. 1 is a diagram illustrating a display device according to one or more embodiments of the present disclosure.

Referring to FIG. 1, a display device 10 according to one or more embodiments of the present disclosure may include a timing controller 11, a data driver 12, a scan driver 13, a pixel unit 14, an emission driver 15, a voltage provider 16, and a park voltage determiner 17.

The timing controller 11 may receive grayscales for image data (or an image frame). The grayscales may include a first color grayscale, a second color grayscale, and a third color grayscale. The first color grayscale is a grayscale for expressing the first color, the second color grayscale is a grayscale for expressing the second color, and the third color grayscale is a grayscale for expressing the third color.

Further, the timing controller 11 may receive a control signal for an image. Such a control signal may include a horizontal synchronization signal (Hsync), a vertical synchronization signal (Vsync), and a data enable signal. The vertical synchronization signal may include a plurality of pulses, and may indicate that a previous frame period ends and a current frame period begins based on a time point at which each of the pulses occurs. The interval between adjacent pulses of the vertical synchronization signal may correspond to one frame period. The horizontal synchronization signal may include a plurality of pulses, and may indicate that a previous horizontal period ends and a new horizontal period begins based on a time point at which each pulse occurs. The interval between adjacent pulses of the horizontal synchronization signal may correspond to one horizontal period. The data enable signal may have an enable level for certain horizontal periods and may have a disable level for the rest of the period. When the data enable signal is at the enable level, it may indicate that color grayscales are supplied in corresponding horizontal periods.

The timing controller 11 may provide the data driver 12 with grayscales rendered or corrected to meet the specifications of the display device 10. Further, the timing controller 11 may provide a clock signal, a scan start signal, and/or the like to the scan driver 13. The timing controller 11 may provide a clock signal, an emission stop signal, and/or the like to the emission driver 15.

The data driver 12 may use the grayscales and control signals received from the timing controller 11 to generate data voltages to provide to the data lines DL1, . . ., DLj, . . ., and DLq. For example, the data driver 12 may sample grayscales using a clock signal and apply data voltages corresponding to the grayscales to the data lines in units of pixel rows. q may be an integer greater than 1, and j may be an integer that is greater than 0 and less than q.

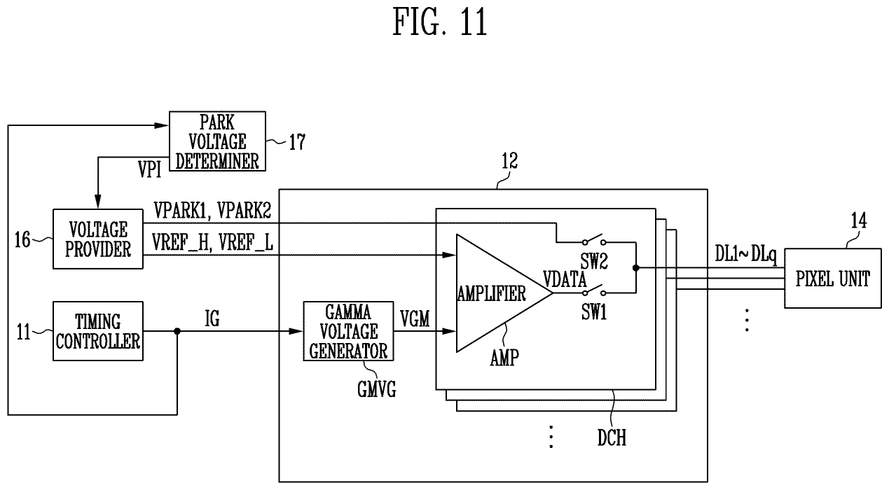

In one or more embodiments, the data driver 12 may selectively apply a data voltage and a park voltage to the data lines DL1 to DLq. The voltage provider 16 may provide a park voltage. The park voltage determiner 17 may determine the park voltage based on grayscales of pixels. Detailed configurations and operations of the data driver 12, the voltage provider 16, and the park voltage determiner 17 will be described in more detail below with reference to FIG. 11.

The scan driver 13 may include first to fourth scan drivers 13GW, 13GB, 13GI, and 13GC. The first scan driver 13GW may provide first scan signals to the first scan lines GW1, . . ., GWi, . . ., and GWp. p may be an integer that is greater than 1, and i may be an integer that is greater than 0 and less than p. The second scan driver 13GB may provide second scan signals to the second scan lines GB1, . . ., GBi, . . ., and GBp. The third scan driver 13GI may provide third scan signals to the third scan lines GI1, . . ., GIi, . . ., and GIp. The fourth scan driver 13GC may provide fourth scan signals to the fourth scan lines GC1, . . ., GCi, . . ., and GCp.

For example, the first scan driver 13GW may receive at least one scan clock signal and a scan start signal from the timing controller 11 to generate first scan signals to be provided to the first scan lines GW1 to GWp. The first scan driver 13GW may sequentially provide first scan signals having a turn-on level of pulse to the first scan lines GW1 to GWp. For example, the first scan driver 13GW may be configured in the form of a shift register, and may generate the first scan signals by sequentially transmitting a scan start signal in the form of pulses of a turn-on level to a next scan stage according to control of the scan clock signal.

Each of the second scan driver 13GB, the third scan driver 13GI, and the fourth scan driver 13GC may be configured similarly to the first scan driver 13GW, and thus a redundant description thereof will be omitted. According to one or more embodiments, at least some of the first to fourth scan drivers 13GW, 13GB, 13GI, and 13GC may be integrated.

The emission driver 15 may receive at least one emission clock signal and an emission stop signal from the timing controller 11 to generate emission signals to be provided to the emission lines EM1, . . ., EMi, . . ., and EMp. The emission driver 15 may sequentially provide emission signals having a turn-off level pulse to the emission lines EM1 to EMp. For example, the emission driver 15 may be configured in the form of a shift register, and may generate emission signals by sequentially transmitting an emission stop signal in the form of pulse of a turn-off level to a next emission stage according to control of the emission clock signal.

In FIG. 1, the number of the first scan lines GW1 to GWp, the number of the second scan lines GB1 to GBp, the number of the third scan lines GI1 to GIp, the number of the fourth scan lines GC1 to GCp, and the number of the emission lines EM1 to EMp are shown as the number p, respectively. However, in one or more other embodiments, at least one of the second scan lines GB1 to GBp, the third scan lines GI1 to GIp, the fourth scan lines GC1 to GCp, or the emission lines EM1 to EMp may be configured to be equal to or less than p/2. For example, two adjacent pixel rows may share one second scan line. Similarly, two adjacent pixel rows may share one third scan line, one fourth scan line, or one emission line. The same pixel row means pixels connected to the same first scan line.

The pixel unit 14 (or the display panel) includes pixels. Each pixel PXij may be connected to a corresponding data line DLj, scan lines GWi, GBi, GIi, GCi, and emission line EMi. Each pixel PXij may include a light-emitting element that emits light based on the received data voltage.

The pixel unit 14 may include first pixels for emitting light of a first color, second pixels for emitting light of the second color, and third pixels for emitting light of third color. The first color, the second color, and the third color may be different respective colors. For example, the first color may be one of red, green, or blue, the second color may be one color other than the first color among red, green, or blue, and the third color may be the rest of the colors other than the first and second colors among red, green, or blue. In addition, magenta, cyan, and yellow may be used instead of red, green, and blue in the first to third colors.

The pixel unit 14 may be arranged in various forms, such as diamond PENTILE™(PENTILE™ being a registered trademark of Samsung Display Co., Ltd., Republic of Korea), RGB-stripe, S-stripe, real RGB, and normal PENTILE™.

At least some of the timing controller 11, the data driver 12, the scan driver 13, the emission driver 15, the voltage provider 16, and the park voltage determiner 17 may be configured as one integrated circuit. In addition, at least some of the timing controller 11, the data driver 12, the scan driver 13, the emission driver 15, the voltage provider 16, and the park voltage determiner 17 may be configured to be separated into two or more circuits. Separately configured circuits may be included as part of other circuits.

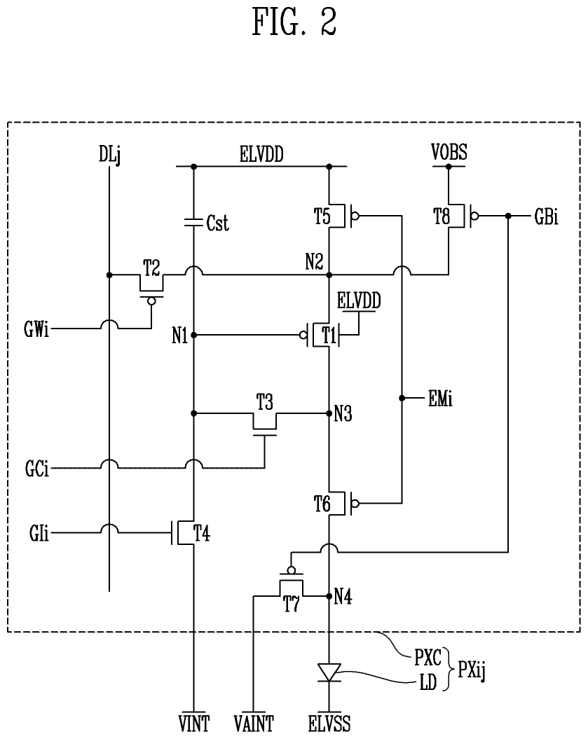

FIG. 2 is a diagram illustrating a pixel according to one or more embodiments of the present disclosure.

Referring to FIG. 2, the pixel PXij may include a pixel circuit PXC and a light-emitting element LD. The pixel circuit PXC includes transistors T1, T2, T3, T4, T5, T6, T7, and T8, and a storage capacitor Cst.

The pixel PXij may be located in an i-th pixel row and may be located in a j-th pixel column. The pixel PXij may be a first pixel for expressing a first color. Because the second pixel for expressing the second color and the third pixel for expressing the third color may be configured in the same manner as the first pixel, redundant description is omitted.

The P-type transistors may be polysilicon semiconductor transistors. In the polysilicon semiconductor transistor, the channel of the active layer may include a polysilicon semiconductor. For example, the polysilicon semiconductor transistor may be a low temperature poly-silicon (LTPS) thin film transistor. The polysilicon semiconductor transistor has high electron mobility, and thus has fast driving characteristics.

The N-type transistors may be oxide semiconductor transistors. In the oxide semiconductor transistor, the channel of the active layer may include an oxide semiconductor. For example, the oxide transistor may be a low temperature polycrystalline oxide (LTPO) thin film transistor. The oxide semiconductor transistor has a lower charge mobility than the polysilicon semiconductor transistor. Accordingly, the amount of leakage current generated in the turn-off state of the oxide semiconductor transistors may be less than that of the polysilicon semiconductor transistors.

The first transistor T1 may have a gate electrode connected to the first node N1, a first electrode connected to the second node N2, and a second electrode connected to the third node N3. The first transistor T1 may be a driving transistor. The first transistor T1 may be a P-type transistor. According to one or more embodiments, the first transistor T1 may include a sub-gate electrode (or a back-gate electrode, a body), and the sub-gate electrode may receive the first power supply voltage ELVDD. According to one or more embodiments, a sub-gate electrode of the first transistor T1 may be connected to a gate electrode (that is, a first node). According to one or more embodiments, the sub-gate electrode of the first transistor T1 may not be present.

The second transistor T2 may have a gate electrode connected to the first scan line GWi, a first electrode connected to the data line DLj, and a second electrode connected to the second node N2. The second transistor T2 may be a switching transistor. The second transistor T2 may be a P-type transistor.

The first scan driver 13GW may provide a first scan signal for controlling timing at which the pixel PXij receives a data voltage. For example, the second transistor T2 that has received the first scan signal at the turn-on level may be turned on, and the second transistor T2 may apply a data voltage applied to the data line DLj to the second node N2.

The third transistor T3 may have a gate electrode connected to the fourth scan line GCi, a first electrode connected to the first node N1, and a second electrode connected to the third node N3. The third transistor T3 may be a diode-connected transistor. The third transistor T3 may be an N-type transistor.

The fourth transistor T4 may have a gate electrode connected to the third scan line GIi, a first electrode connected to the first node N1, and a second electrode receiving the first initialization voltage VINT. The fourth transistor T4 may be a gate initialization transistor. The fourth transistor T4 may be an N-type transistor.

In the fifth transistor T5, a gate electrode may be connected to the emission line EMi, a first electrode may receive the first power supply voltage ELVDD, and a second electrode may be connected with the second node N2. The fifth transistor T5 may be a first emission control transistor. The fifth transistor T5 may be a P-type transistor.

The sixth transistor T6 may have a gate electrode connected to the emission line EMi, a first electrode connected to the third node N3, and a second electrode connected to the fourth node N4. The sixth transistor T6 may be a second emission control transistor. The sixth transistor T6 may be a P-type transistor.

The seventh transistor T7 may have a gate electrode connected to the second scan line GBi, a first electrode receiving a second initialization voltage VAINT (or an anode initialization voltage), and a second electrode connected to the fourth node N4. The seventh transistor T7 may be an anode initialization transistor. The seventh transistor T7 may be a P-type transistor.

The second scan driver 13GB may provide a second scan signal for controlling the timing of application of the second initialization voltage VAINT (or the anode initialization voltage) to the anode electrode of the light-emitting element LD. For example, the seventh transistor T7 that has received the second scan signal at the turn-on level is turned on, and the second initialization voltage VAINT is applied to the anode of the light-emitting element LD, so that the anode voltage of the light-emitting element LD can be initialized to the second initialization pressure VAINT.

In the eighth transistor T8, a gate electrode may be connected to the second scan line GBi, a first electrode may receive the bias voltage VOBS, and a second electrode may be connected with the second node N2. The eighth transistor T8 may be a bias transistor. The eighth transistor T8 may be a P-type transistor.

In the storage capacitor Cst, the first electrode may receive the first power supply voltage ELVDD, and the second electrode may be connected to the first node N1.

In the light-emitting element LD, an anode electrode may be connected to the fourth node N4, and a cathode electrode may receive the second power supply voltage ELVSS. The light-emitting element LD may emit light in one of a first color, a second color, or a third color. The light-emitting element LD may be a light-emitting diode. The light-emitting element LD may be composed of an organic light-emitting diode, an inorganic light-emitting diode, a quantum dot/well light-emitting diode, or the like. There might be only one light-emitting element LD provided in each pixel, but in one or more other embodiments, a plurality of light-emitting elements may be provided in each pixel. In this case, a plurality of light-emitting elements may be connected in series, parallel, or in series-parallel.

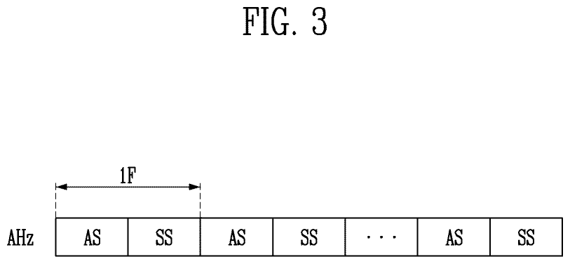

FIGS. 3 to 6 are diagrams for describing a change in a display frequency according to one or more embodiments of the present disclosure.

The display device 10 can support a variable refresh rate. The refresh rate is a frequency at which a data voltage is written to the pixel PXij, also referred to as a screen scan rate or a screen reproduction rate, and may indicate the number of image frames reproduced for one second.

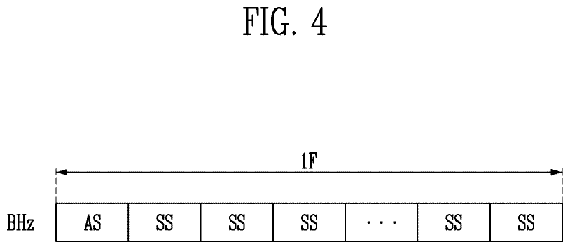

The pixel unit 14 may display an image at a first frequency AHz in the first mode (see FIG. 3), and may display an image at a second frequency BHz that is less than the first frequency AHz (see FIG. 4) in the second mode.

For example, each frame period 1F in the first mode may include, for each pixel PXij, one address scan period AS. In one or more embodiments, each frame period 1F in the first mode may further include, for each pixel PXij, one Self Scan Period (SS).

For example, each frame period 1F in the second mode may include (e.g., for each pixel PXij) one address scan period AS and a plurality of self-scan periods SS. As the second frequency BHz is smaller, the number of self-scan periods SS included in one frame period 1F may increase. For another example, each frame period 1F in a corresponding mode may include (e.g., for each pixel PXij) only one address scan period AS, and not a self-scan period SS.

The address scan period AS is a period in which a data voltage is written to the pixel PXij. The address scan period AS may be referred to as a data-programming period that receives a data voltage from the data line DLj.

The self-scan period SS is a period in which a data voltage is not written to the pixel PXij. During the emission period of the self-scan period SS, the pixel PXij may emit light using the data voltage written in the address scan period AS. For example, the length of the self-scan period SS may be the same as the length of the address scan period AS. In one or more other embodiments, the length of the self-scan period SS may be shorter than the length of the address scan period AS. For example, the length of the self-scan period SS may correspond to half of the length of the address scan period AS. For another example, the length of the address scan period AS may be an integer multiple of the length of the self-scan period SS.

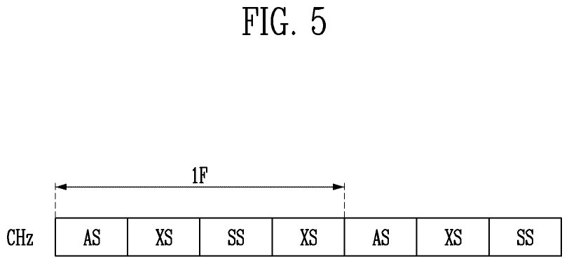

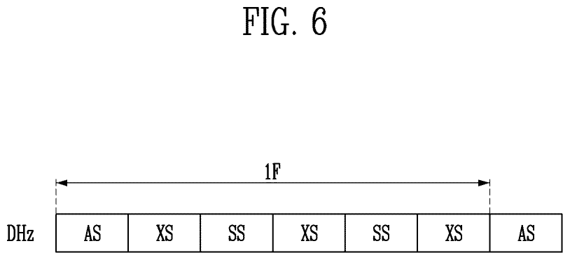

The pixel unit 14 may display an image at a third frequency CHz in a third mode (see FIG. 5), and may display an image at the fourth frequency DHz that is less than the third frequency CHz (see FIG. 6) in a fourth mode.

In the third mode and the fourth mode, an auxiliary scan period XS subsequent to the address scan period AS, and an auxiliary scan period XS subsequent to the self-scan period SS may be included.

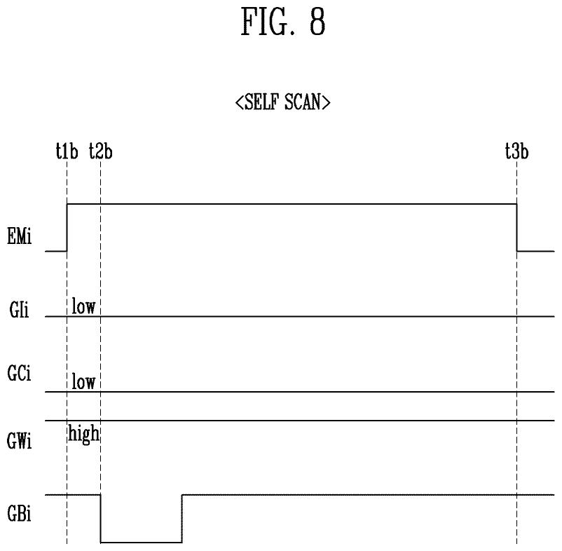

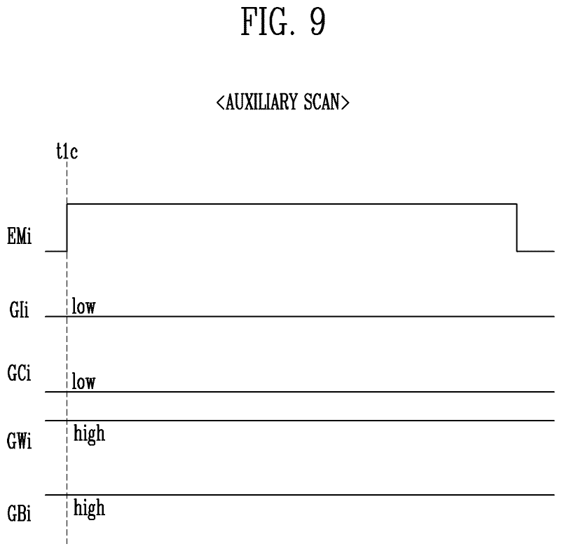

The auxiliary scan period XS may be similar to the self-scan period SS, in that it is a period in which the data voltage is not written to the pixel PXij. During the emission period of the auxiliary scan period XS, the pixel PXij may emit light using the data voltage written in the address scan period AS. For example, the length of the auxiliary scan period XS may be the same as the length of the address scan period AS. However, the auxiliary scan period XS is different from the self-scan period SS in that the second scan signal at the turn-on level is not supplied, which is described further below with respect to FIGS. 8 and 9.

The display device 10 may display an image in a plurality of modes. The display device 10 does not necessarily include all of the first mode, the second mode, the third mode, and the fourth mode to be driven. The display device 10 may be driven only in at least one of the first mode, the second mode, the third mode, or the fourth mode. For example, the display device 10 may be driven in only one of the first mode, the second mode, the third mode, or the fourth mode. Further, the display device 10 may be driven only in the first mode and the second mode while not being driven in the third mode and the fourth mode. Meanwhile, the display device 10 may be driven only in the third mode and the fourth mode while not being driven in the first mode and the second mode.

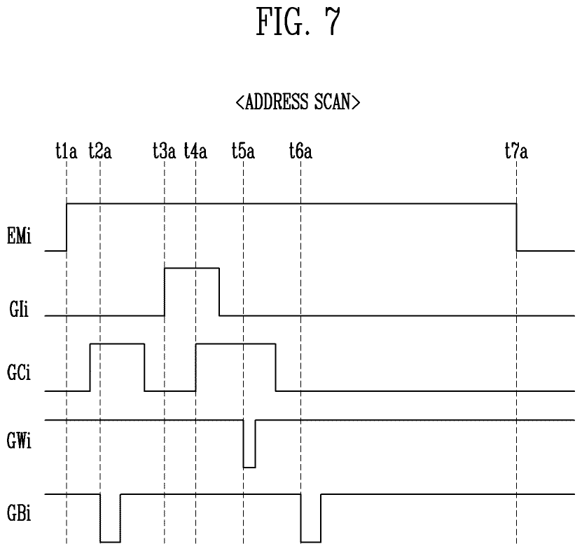

FIG. 7 is a diagram illustrating an address scan period according to one or more embodiments of the present disclosure. In describing FIG. 7, refer to the pixel PXij of FIG. 2.

At the time point t1a, an emission signal at a turn-off level (high level) is applied to the emission line EMi, so that the fifth transistor T5 and the sixth transistor T6 are turned off, and the pixel PXij is in a non-emission state.

At the time point t2a, a second scan signal at a turn-on level (low level) is applied to the second scan line GBi, whereby the seventh transistor T7 and the eighth transistor T8 are turned on. Further, a fourth scan signal at a turn-on level (high level) is applied to the fourth scan line GCi, whereby the third transistor T3 is turned on. In this case, a bias voltage VOBS that is higher than the gate electrode (first node N1) is applied to the source electrode (second node N2) of the first transistor T1, whereby the first transistor T1 may be on-biased. When the first transistor T1 is on-biased, the data voltage of the current frame input thereafter may be lower than the bias voltage VOBS. Thus, hysteresis may be reduced or prevented regardless of the magnitude of the data voltage of the previous frame.

For reference, a hysteresis phenomenon refers to a phenomenon in which a source-drain current curve versus a gate-source voltage of a transistor when a data voltage of a current frame is higher than a data voltage of the previous frame is different from a source-drain current curve versus a gate-source voltage of the transistor when the data voltage of the current frame is lower than the data voltage of a previous frame.

At the time point t3a, a third scan signal at a turn-on level (high level) is applied to the third scan line GIi, whereby the fourth transistor T4 is turned on. Accordingly, the first initialization voltage VINT is applied to the first node N1. The first initialization voltage VINT is a sufficiently low voltage, and the first transistor T1 may be turned on.

At the time point t4a, a fourth scan signal at a turn-on level (high level) is applied to the fourth scan line GCi, whereby the third transistor T3 is turned on. Accordingly, the first transistor T1 is in a diode-connected state in which a drain electrode and a gate electrode are connected.

At the time point t5a, a scan signal at a turn-on level (low level) is applied to the first scan line GWi, whereby the second transistor T2 is turned on. Accordingly, the data voltage of the data line DLj may be applied to the first node N1 through the second transistor T2, the first transistor T1, and the third transistor T3, which are in the turn-on state. In this case, the voltage of the first node N1 may be a compensation voltage obtained by subtracting the threshold voltage of the first transistor T1 from the data voltage. The storage capacitor Cst may maintain a difference between the first power supply voltage ELVDD and the compensation voltage.

At the time point t6a, a scan signal at a turn-on level (low level) is applied to the second scan line GBi, whereby the seventh transistor T7 and the eighth transistor T8 are turned on. As the seventh transistor T7 is turned on, a second initialization voltage VAINT is applied to the anode of the light-emitting element LD, and the light-emitting element LD may be initialized with an amount of charge corresponding to a voltage difference between the second initialization voltage VAINT and the second power supply voltage ELVSS. Accordingly, low-grayscale representation of the light-emitting element LD can be facilitated.

At the time point t7a, the fifth transistor T5 and the sixth transistor T6 can be turned on by applying an emission signal at a turn-on level (low level) to the emission line EMi. Accordingly, a path of a driving current flowing from the first power supply voltage ELVDD toward the second power supply voltage ELVSS via the fifth transistor T5, the first transistor T1, the sixth transistor T6, and the light-emitting element LD is formed.

The amount of driving current may be adjusted according to the voltage held in the storage capacitor Cst. The light-emitting element LD emits light with luminance corresponding to the amount of driving current. The light-emitting element LD may emit light until an emission signal at a turn-off level is applied to the emission line EMi.

FIG. 8 is a diagram illustrating a self-scan period according to one or more embodiments of the present disclosure. In describing FIG. 8, refer to the pixel PXij of FIG. 2.

At the time point t1b, an emission signal at a turn-off level (high level) is applied to the emission line EMI, so that the fifth transistor T5 and the sixth transistor T6 are turned off, and the pixel PXij is in a non-emission state.

During the self-scan period t1b to t3b, scan signals at the turn-off level are maintained in the first scan line GWi, the third scan line GIi, and the fourth scan line GCi. Accordingly, the voltage of the first node N1 does not changed.

At the time point t2b, a scan signal at a turn-on level (low level) is applied to the second scan line GBi, whereby the seventh transistor T7 and the eighth transistor T8 are turned on. As the seventh transistor T7 is turned on, a second initialization voltage VAINT is applied to the anode of the light-emitting element LD, and the light-emitting element LD may be initialized with an amount of charge corresponding to a voltage difference between the second initialization voltage VAINT and the second power supply voltage ELVSS. Accordingly, low-grayscale representation of the light-emitting element LD can be facilitated. Further, as the eighth transistor T8 is turned on, the source voltage of the first transistor T1 may be initialized. Accordingly, it is possible to reduce or prevent fluctuation of the gate-source voltage difference of the first transistors T1 due to the shaken source voltage of the first transistor T1.

At the time point t3b, the fifth transistor T5 and the sixth transistor T6 may be turned on by applying an emission signal at a turn-on level (low level) to the emission line EMi. Accordingly, a path of a driving current flowing from the first power supply voltage ELVDD toward the second power supply voltage ELVSS via the fifth transistor T5, the first transistor T1, the sixth transistor T6, and the light-emitting element LD is formed.

The amount of driving current may be adjusted according to the voltage held in the storage capacitor Cst. Because the voltage of the first node N1 recorded during the address scan period AS is maintained during the self-scan period SS, the luminance of the light-emitting element LD in the self-scan period SS may be the same as the luminance of the light-emitting element LD in the address scan period AS.

FIG. 9 is a diagram illustrating an auxiliary scan period according to one or more embodiments of the present disclosure.

The auxiliary scan period of FIG. 9 is an example of the auxiliary scan period XS of FIGS. 5 and 6. During the auxiliary scan period of FIG. 9, the emission signal of the emission line EMi may have the same waveform as the signals of the address scan period in FIG. 7. However, the first to fourth scan signals may maintain a turn-off level. Accordingly, the voltage of the first node N1 does not change, and a voltage difference between both ends of the storage capacitor Cst may be maintained. Accordingly, the luminance of the light-emitting element LD after the auxiliary scan period of FIG. 9 may be the same as the luminance of the light-emitting element LD after the immediately preceding address scan period.

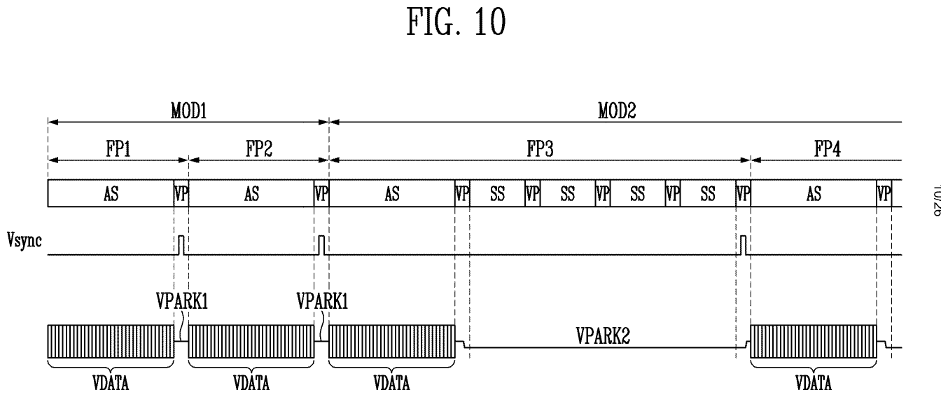

FIG. 10 is a diagram for describing a mode and a park voltage of a display device according to one or more embodiments of the present disclosure.

Referring to FIG. 10, an example in which the display device 10 is sequentially driven in the first mode MOD1 and the second mode MOD2 is disclosed. For example, during the first frame period FP1 and the second frame period FP2, the display device 10 may be driven in the first mode MOD1. During the third frame period FP3 and the fourth frame period FP4, the display device 10 may be driven in the second mode MOD2.

The first mode MOD1 may be a mode in which an image is displayed at a first frequency, and the second mode MOD2 may be a mode of displaying an image at a second frequency. The second frequency may be less than the first frequency. Accordingly, each of the third frame period FP3 and the fourth frame period FP4 may be longer than each of the first frame period FP1 and the second frame period FP2, respectively.

It may be assumed that each of the frame periods FP1 and FP2 in the first mode MOD1 includes one address scan period AS and a porch period VP. It is assumed that each of the frame periods FP3 and FP4 in the second mode MOD2 includes one address scan period AS, a plurality of self-scan periods SS, and a plurality of porch periods VP. The porch period VP may be a transitional period between adjacent scan periods AS.

The processor may transmit the vertical synchronization signal Vsync and the image data. The vertical synchronization signal Vsync may include a plurality of pulses, and may indicate that a previous frame period ends and that a current frame period begins based on a time point at which each of the pulses occurs. The interval between adjacent pulses of the vertical synchronization signal Vsync may correspond to one frame period. A pulse of the vertical synchronization signal Vsync may occur in the porch period VP immediately before the address scan period AS.

The data driver 12 may selectively apply the data voltages VDATA and the park voltages VPARK1 and VPARK2 to the data lines DL1 to DLq. The park voltages VPARK1 and VPARK2 may be voltages during an idle period that are not recorded in the pixel, and that are applied only to the data lines DL1 to DLq. By applying the park voltages VPARK1 and VPARK2 instead of the data voltages VDATA during the idle period, it is possible to reduce the power consumption of the data driver 12.

The first park voltage VPARK1 may be provided to the data lines DL1 to DLq in the first mode MOD1 for a first period. In one or more embodiments, the first period may include a porch period VP immediately before the address scan period AS. In one or more embodiments, the first period may include a porch period VP immediately after the address scan period AS. In one or more embodiments, the first period may include a porch period VP immediately before and after the address scan period AS.

In one or more embodiments, the first period may include a porch period VP immediately before or after the second park voltage VPARK2 is applied. For example, the first park voltage VPARK1 may be provided to the data lines DL1 to DLq in the second mode MOD2.

The second park voltage VPARK2 may be provided to the data lines DL1 to DLq in the second mode MOD2 for a second period. The second park voltage VPARK2 may not be provided to the data lines DL1 to DLq in the first mode MOD1. In one or more embodiments, the second period may include a porch period VP between adjacent self-scan periods SS. In one or more embodiments, the second period may include a porch period VP between an address scan period AS and a self-scan period SS. The second period in which the second park voltage VPARK2 is continuously applied may be longer than the first period in which the first park voltage VPARK1 is continuously applied.

In some cases, image quality degradation due to the park voltages VPARK1 and VPARK2 may occur. For example, timing at which the data driver 12 applies the first park voltage VPARK1 and timing at which the second scan driver 13GB supplies the second scan signals at the turn-on level may partially overlap in time. In this case, noise may occur in the voltage of the second node N2 of the pixel PXij due to voltage coupling, and the gate-source voltage difference of the first transistor T1 may not be maintained, which may lead to a decrease in image quality.

Meanwhile, timing at which the data driver 12 applies the second park voltage VPARK2 and timing at which the second scan driver 13GB supplies the second scan signals at the turn-on level may overlap in time. For example, because the second park voltage VPARK2 is applied for a relatively long time, voltage coupling may appear throughout the pixel unit 14. In this case, an undesirable flicker phenomenon may occur.

FIG. 11 is a diagram illustrating a park voltage determiner according to one or more embodiments of the present disclosure.

The park voltage determiner 17 may determine the park voltages VPARK1 and VPARK2 based on the grayscales IG for the pixels. The park voltage determiner 17 may provide park voltage information VPI for the determined voltage levels of the park voltages VPARK1 and VPARK2.

The voltage provider 16 may provide the park voltages VPARK1 and VPARK2. The voltage provider 16 may receive the park voltage information VPI, and may generate the park voltages VPARK1 and VPARK2 at voltage levels indicated by the park voltage information VPI. In addition, the voltage provider 16 may provide a first source reference voltage VREF_H and a second source reference voltage VREF_L.

The data driver 12 may include a gamma voltage generator GMVG, and a plurality of data channels DCH. The data channels DCH may be connected to the data lines DL1 to DLq. The gamma voltage generator GMVG may generate gamma voltages VGM, and may provide gamma voltages VGM corresponding to the grayscales IG received from the timing controller 11. Each data channel DCH may include an amplifier AMP. The amplifier AMP may output the input gamma voltage VGM as the data voltage VDATA, and may provide the data voltage VDATA to a connected data line (e.g., of the data lines DL1 to DLq). In this case, an upper limit of the voltage level of the amplifier AMP may be determined by the first source reference voltage VREF_H, and a lower limit of the voltage level of the amplifier AMP may be determined by the second source reference voltage VREF_L.

The data driver 12 may selectively apply the data voltage VDATA and the park voltages VPARK1 and VPARK2 to the data lines DL1 to DLq. For example, the data channel DCH may include a first switch SW1 and a second switch SW2. When the data driver 12 applies the data voltage VDATA to the data lines DL1 to DLq, the first switch SW1 may be turned on. When the data driver 12 applies the park voltages VPARK1 and VPARK2 to the data lines DL1 to DLq, the second switch SW2 may be turned on.

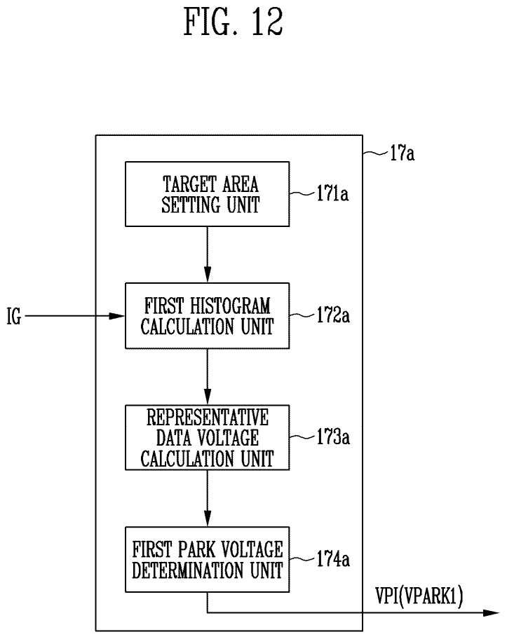

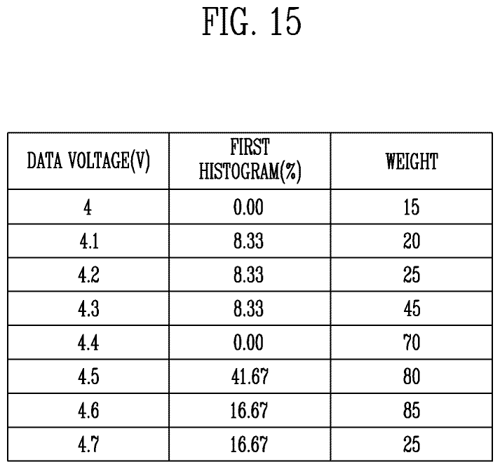

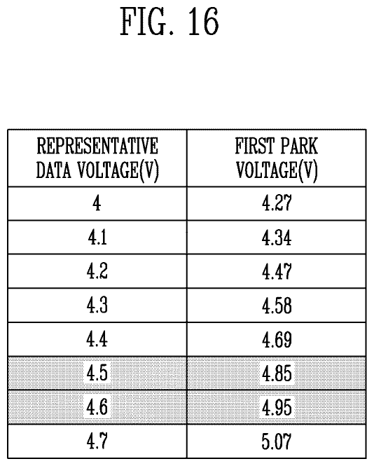

FIGS. 12 to 16 are diagrams for describing a process in which the park voltage determiner determines the first park voltage. The tables of FIGS. 15 and 16 may be stored in the park voltage determiner 17a in the form of a lookup table, or may be stored in another memory.

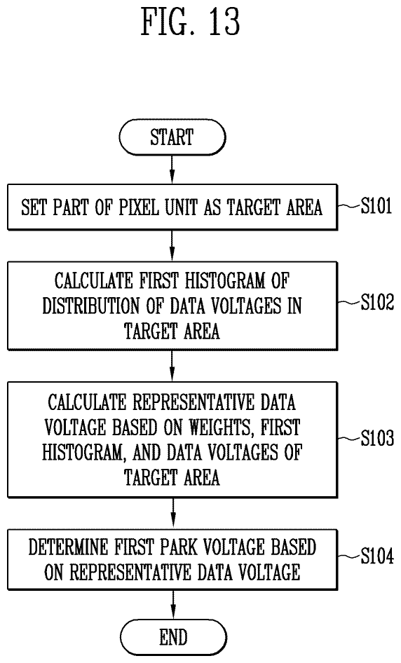

Referring to FIG. 12, a park voltage determiner 17a according to one or more embodiments of the present disclosure is shown as an example. The park voltage determiner 17 of FIG. 11 may include the park voltage determiner 17a of one or more embodiments. Referring to FIG. 13, operations S101, S102, S103, and S104 of the park voltage determiner 17a are illustrated as an example. Operations S101, S102, S103, and S104 of the park voltage determiner 17a may be performed once per one frame period based on the vertical synchronization signal Vsync.

The park voltage determiner 17a may include a target area setter (e.g., a target-area-setting unit) 171a, a first histogram calculator (e.g., a first histogram calculation unit) 172a, a representative data voltage calculator (e.g., a representative data voltage calculation unit) 173a, and a first park voltage determiner (a first park voltage determination unit) 174a.

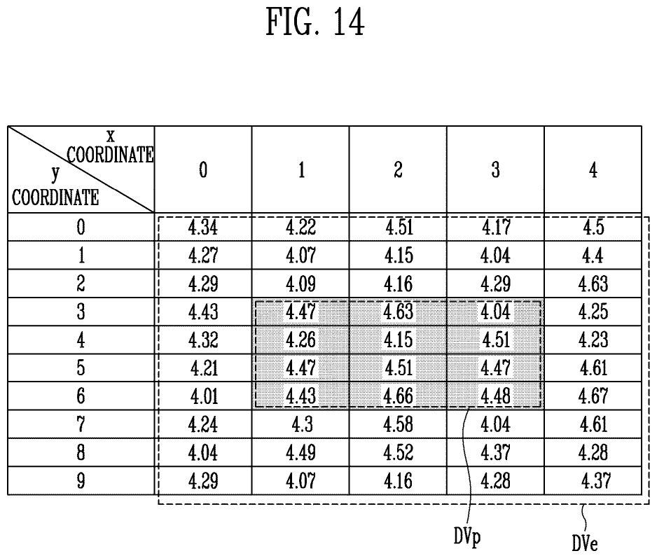

The target area setter 171a may set a part of the pixel unit 14 as the target area (S101). Referring to FIG. 14, data voltages DVe for an image frame of the pixel unit 14 are shown as an example. For example, it may be assumed that the pixel unit 14 includes 10 pixel rows and 5 pixel columns. Thus, as shown in the table of FIG. 14, each pixel may be defined by an x coordinate of 0 to 4 and a y coordinate of 0 to 9.

One or more of first timings at which the data driver 12 applies the first park voltage VPARK1 to the data lines DL1 to DLq may overlap one or more of second timings at which a second scan driver 13GB applies the second scan signals at the turn-on level to the second scan lines GB1 to GBp (see FIG. 1). In this case, noise may occur in the voltage of the second node N2 of the pixel PXij due to voltage coupling, and the gate-source voltage difference of the first transistor T1 may not be maintained, which may lead to a decrease in image quality (see FIG. 2).

When the above-described first timing(s) and second timing(s) overlap, the target area setter 171a may set the target area to include pixels connected to the data line corresponding to the first timing and the second scan line corresponding to the second timing. In the case of FIG. 14, it may be assumed that the target area setter 171a sets x coordinates of 0 to 1 and y coordinates of 3 to 6 as the target area.

The first histogram calculator 172a may calculate a first histogram of the distribution of the data voltages DVp in the target area (S102). The first histogram calculator 172a may calculate the data voltages DVp of the target area with reference to the grayscales IG of the image frame. The formula for converting a grayscale to a data voltage may be in accordance with known techniques. In one or more other embodiments, the first histogram calculator 172a may directly receive values of the data voltages DVp corresponding to grayscales of the image frame.

Referring to FIG. 15, a first histogram is shown that groups the data voltages DVp of the target area in units of 0.1 volts (V), and shows the corresponding percentage for each of the groups. In addition, a weight corresponding to the degree to which the data voltage can act as noise on the image is shown. For example, in the manufacturing operation of the display device 10, a measurement device including a luminance meter may apply various data voltages and the first park voltage VPARK1, and may set the weight to be larger as the noise of the image according to the difference between the data voltage and the first park pressure VPARK1 is larger.

In the case of FIG. 15, among the data voltages DVp, the case where data voltage is less than about 4 volts is shown as 0%, and the case where the data voltage is greater than about 4 volts and less than about 4.1 volts is shown as 8.33%. Similarly, the case where the data voltage is greater than about 4.4 volts and less than about 4.5 volts is shown as 41.67%.

The representative data voltage calculator 173a may calculate a representative data voltage of the target area. For example, the representative data voltage calculator 173a may calculate the representative data voltage based on the weights, the first histogram, and the data voltages DVp of the target area (S103, see Equation 1).

$$D V r = SUM ( D V u * His * Nw ) / SUM ( His * Nw ) \qquad Equation 1$$

Here, DVr may be a representative data voltage, SUM may be a sum function, DVu may be an upper limit data voltage of each group (data voltages of each group shown in the table of FIG. 15), His may be a first histogram value corresponding to each group, and Nw may be a weight corresponding to each group.

According to one or more embodiments, the representative data voltage calculator 173a may determine, as the representative data voltage, at least one of a mode value among the data voltages DVp of the target area (for example, the data voltage having the highest percentage in the first histogram), an average value of the data voltages DVp, or a median value of the data voltages DVp.

The first park voltage determiner 174a may determine the first park voltage VPARK1 based on the representative data voltage (S104). The first park voltage determiner 174a may provide a voltage level of the determined first park voltage VPARK1 as park voltage information VPI.

Referring to FIG. 16, for each representative data voltage, first park voltages capable of reducing or minimizing noise caused by the representative data voltage on an image are shown as an example. For example, in the manufacturing operation of the display device 10, the measurement device including the luminance meter may apply various representative data voltages and the first park voltage VPARK1 to identify the first park voltage VPARK1 that may cause the least noise to the image composed of the representative data voltages, and may create a lookup table.

If the representative data voltage corresponds to one of the data in the lookup table of FIG. 16, the first park voltage determiner 174a may immediately determine the first park voltage VPARK1 corresponding to the representative data voltage. However, in the case of FIG. 15, the representative data voltage may be calculated to be 4.503 volts based on Equation 1.

In this case, the first park voltage VPARK1 may be calculated based on representative data voltages closest to the calculated representative data voltage and first park voltages corresponding to the adjacent representative data voltages (see Equation 2).

$$4.85 + ( 4.95 - 4.85 ) / 0.1 * 0.003 = 4.853 \qquad Equation 2$$

Referring to Equation 2, by interpolating using representative data voltages 4.5 volts and 4.6 volts closest to 4.503 volts and corresponding first park voltages 4.85 volts and 4.95 volts, it can be seen that the first park voltage VPARK1 can be finally calculated to be 4.853 volts.

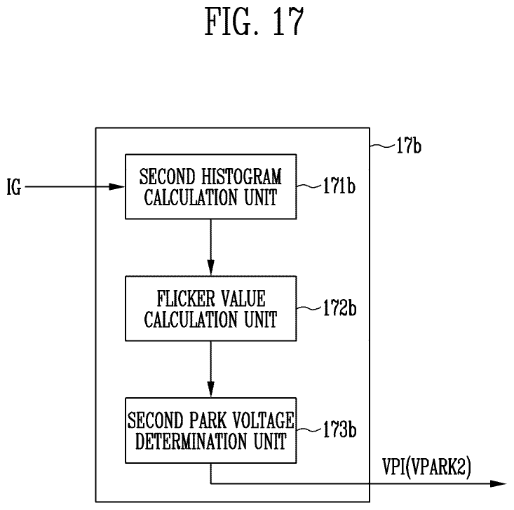

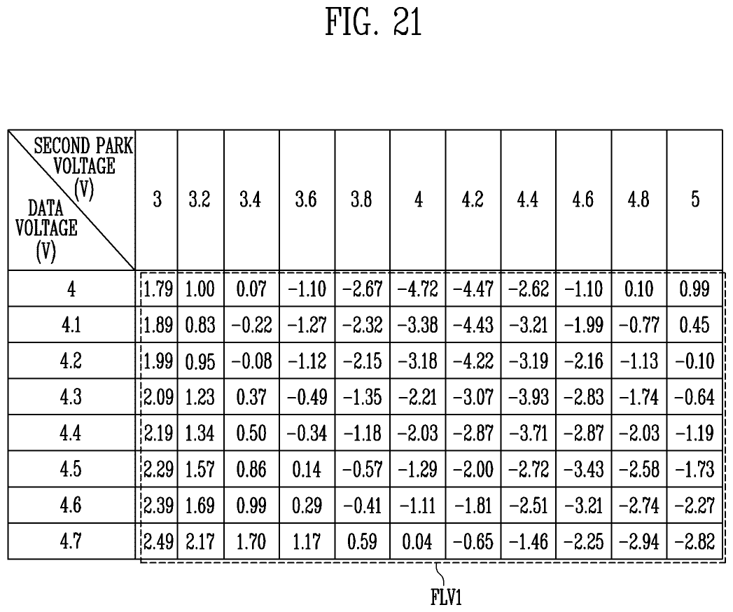

FIGS. 17 to 22 are diagrams for describing a process in which the park voltage determiner determines the second park voltage. The table of FIG. 21 may be stored in the park voltage determiner 17b in the form of a lookup table, or may be stored in another memory.

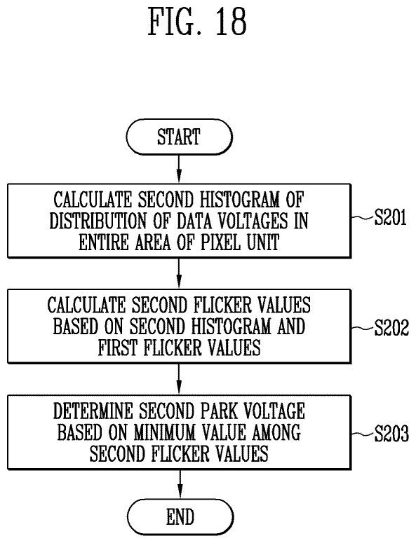

Referring to FIG. 17, a park voltage determiner 17b according to one or more embodiments of the present disclosure is shown as an example. The park voltage determiner 17 of FIG. 11 may include the park voltage determiner 17b of one or more embodiments. Referring to FIG. 18, operations S201, S202, and S203 of the park voltage determiner 17b are illustrated as an example. Operations S201, S202, and S203 of the park voltage determiner 17b may be performed once per one frame period based on the vertical synchronization signal Vsync.

The park voltage determiner 17b may include a second histogram calculator 171b, a flicker value calculator (e.g., a flicker value calculation unit) 172b, and a second park voltage determiner 173b.

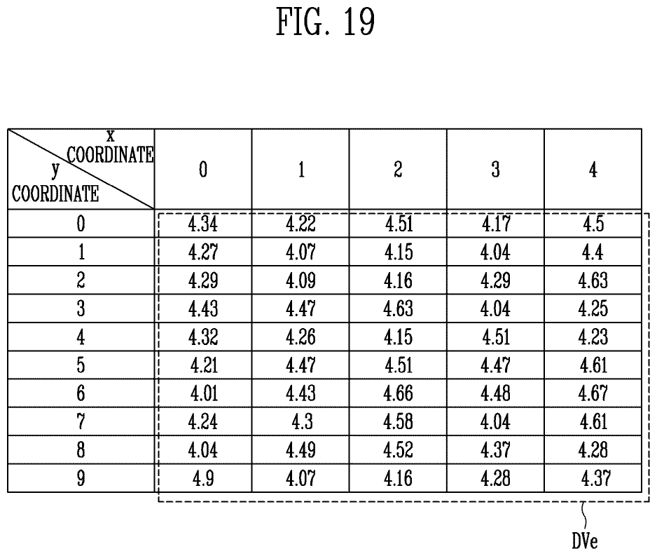

Referring to FIG. 19, data voltages DVe for an image frame of the pixel unit 14 are shown as an example. For example, it may be assumed that the pixel unit 14 includes 10 pixel rows and 5 pixel columns. Thus, as shown in the table of FIG. 19, each pixel may be defined by an x coordinate of 0 to 4 and a y coordinate of 0 to 9.

The timing at which the data driver 12 applies the second park voltage VPARK2 and the timing at which the second scan driver 13GB supplies the second scan signals at the turn-on level may overlap in time. For example, because the second park voltage VPARK2 is applied for a relatively long time, voltage coupling may appear throughout the pixel unit 14. In this case, an undesirable flicker phenomenon may occur. Because the flicker phenomenon may occur throughout the pixel unit 14, it may be suitable to consider the data voltages DVe of the entire area in determining the second park voltage VPARK2.

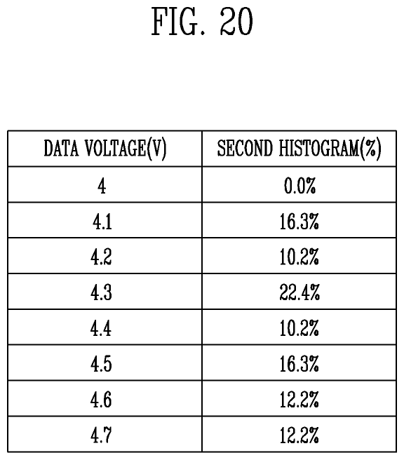

The second histogram calculator 171b may calculate a second histogram of the distribution of the data voltages in the entire area of the pixel unit 14 (S201). The second histogram calculator 171b may calculate data voltages of the entire area with reference to the grayscales IG of the image frame. The formula for converting a grayscale to a data voltage may be in accordance with known techniques. In one or more other embodiments, the second histogram calculator 171b may directly receive values of data voltages corresponding to grayscales of the image frame. For example, referring to FIG. 20, a second histogram is shown that groups the data voltages DVe of the entire area of the pixel unit 14 by 0.1 volts (V) and shows what percentage among the total 100 percentage the group corresponds to.

Referring to FIGS. 18 and 21, the flicker value calculator 172b may calculate second flicker values based on the second histogram and first flicker values FLV1 (S202). Shown, as an example, are the first flicker values FLV1 when a second park voltage VPARK2 for a data voltage is set. Because the lower the first flicker value FLV1 means that the flicker phenomenon appears less, a lower first flicker value FLV1 may be suitable. In the manufacturing operation of the display device 10, the measurement device including the luminance meter may set the first flicker value to correspond to the generated flicker frequency and intensity while applying various data voltages and the second park voltage VPARK2. That is, the first flicker value may not have a special unit, but may be a user-defined value.

For example, the flicker value calculator 172b may calculate the second flicker value corresponding to the second park voltage VPARK2 by summing the values corresponding to the same second park voltage VPARK2 among the values obtained by multiplying the first flicker value FLV1 and the second histogram corresponding to the same data voltage.

For example, when the second park voltage VPARK2 is about 4.8 volts, it may be calculated by the following Equation 3 using the numerical values of FIGS. 20 and 21.

$$0.1 * 0 + ( - 0. 77 ) * 0.163 + ( - 1. 13 ) * 0.102 + ( - 1.74 ) * 0.224 + ( - 2.03 ) * 0.102 + ( - 2. 58 ) * 0.163 + ( - 2.74 ) * 0.122 + ( - 2.94 ) * 0.122 = - 1.951 \qquad Equation 3$$

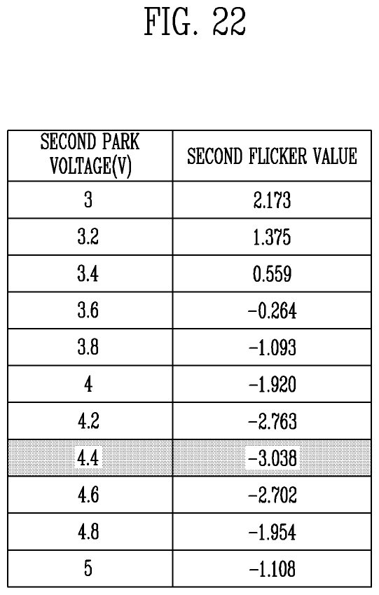

When the second park voltage VPARK2 is about 4.8 volts, the second flicker value may be calculated as about −1.951 according to Equation 3. Referring to FIG. 22, when the second park voltage VPARK2 is about 4.8 volts, there is a slight difference in the second flicker value of about −1.954, but this may be ignored as a difference that may vary depending on how far a decimal point is to be calculated during calculation.

The second park voltage determiner 173b may determine the second park voltage VPARK2 based on a minimum value among the second flicker values (S203). For example, referring to FIG. 22, second flicker values calculated for the second park voltages VPARK2 are shown. The minimum value of the second flicker values is about −3.038, which corresponds to the second park voltage VPARK2 of about 4.4 volts. Accordingly, the second park voltage determiner 173b may provide about 4.4 volts as the voltage level of the second park voltage VPARK2 as the park voltage information VPI.

The display device according to one or more embodiments may be applied to various electronic devices. The electronic device according to one or more embodiments includes the above-described display device, and may further include a module or device having an additional function other than the display device.

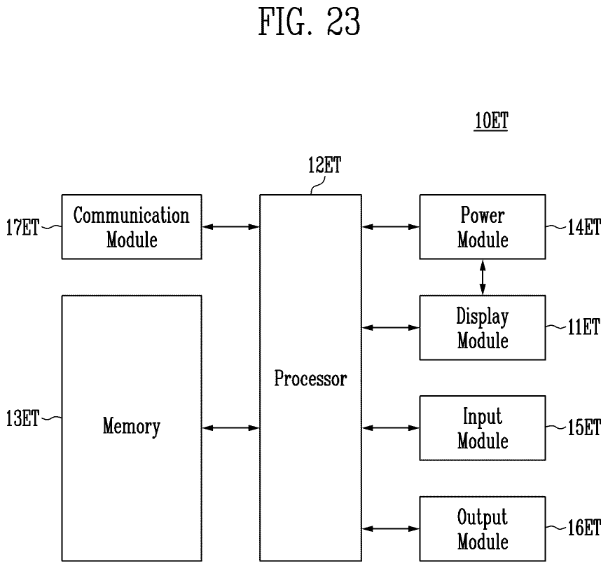

FIG. 23 is a block diagram of an electronic device according to one or more embodiments. Referring to FIG. 23, an electronic device 10ET according to one or more embodiments may include a display module 11ET, a processor 12ET, a memory 13ET, and a power module 14ET. The display module 11ET may be represented by a display device.

The processor 12ET may include at least one of a central processing unit (CPU), an application processor (AP), a graphics processing unit (GPU), a communication processor (CP), an image signal processor (ISP), or a controller. In one or more embodiments, the processor 12ET may be provided divided into two or more from a functional or structural point of view. For example, the processor 12ET may include a main processor in the form of a first drive chip including a central processing unit, and an auxiliary processor in the form of the second drive chip including a controller that receives an image signal from the main processor and processes the image signal to meet an interface specification of the display module 11ET. The processor 12ET may provide image data. The display module 11ET may display an image based on grayscales of image data.

The memory 13ET may include at least one of a non-volatile memory or a volatile memory. Data information suitable for the operation of the processor 12ET or the display module 11ET may be stored in the memory 13ET. When the processor 12ET executes an application stored in the memory 13ET, an image data signal and/or an input control signal are transmitted to the display module 11ET, and the display module 11ET may process the received signal and output image information through a display screen.

The power module 14ET may include a power supply module, such as a power adapter or a battery device, and a power conversion module that converts power supplied by the power supply module to generate power required for operation of the electronic device 10ET. The power conversion by the power conversion module may include, but is not limited to, DC-DC conversion, AC-DC conversion, and DC-AC conversion.

The electronic device 10ET may further include an input module 15ET, a non-image output module 16ET, and/or a communication module 17ET.

The input module 15ET may provide input information to the processor 12ET and/or the display module 11ET. The input module 15ET may include physical buttons, keyboards, microphones, as well as various sensor modules. Examples of the sensor module may include a touch sensor, a pressure sensor, a distance sensor, a position sensor, a digitizer, a motion recognition sensor, a camera sensor, a light receiving sensor, a photoelectric conversion sensor, a temperature sensor, as well as a biometric sensor, such as a blood pressure sensor, a blood glucose sensor, an electrocardiogram sensor, a heart rate sensor, and/or the like.

The non-image output module 16ET may receive information other than the image received from the processor 12ET, and may provide the information to the user. Examples of the non-image output module 16ET include an acoustic module, a haptic module, a light-emitting module, and/or the like, and may include other functional modules unique to an electronic device (e.g., a cooling module of a refrigerator and/or the like).

The communication module 17ET is a module that is responsible for transmitting and receiving information between the electronic device 10ET and an external device, and may include a receiver and a transmitter. The communication module 17ET may include various wireless communication modules, such as a mobile communication module, a Wi-Fi® module, and/or a Bluetooth® module (Wi-Fi® being a registered trademark of the non-profit Wi-Fi Alliance Bluetooth® being a registered trademark of Bluetooth Sig, Inc., Kirkland, WA), or various wired communication modules.

At least one of the above-described components of the electronic device 10ET may be included in the display device according to the above-described embodiments. In addition, some of the individual modules functionally included in one module may be included in the display device, and other parts may be provided separately from the display device. For example, the display device may include the display module 11ET, and the processor 12ET, the memory 13ET, and the power module 14ET may be provided in the form of other devices in the electronic device 10ET other than the display device. As another example, the power module 14ET may be provided in the display device, and power may be supplied to the processor 12ET and the memory 13ET provided in the electronic device 10ET other than the display device, which is not limited to the above example.

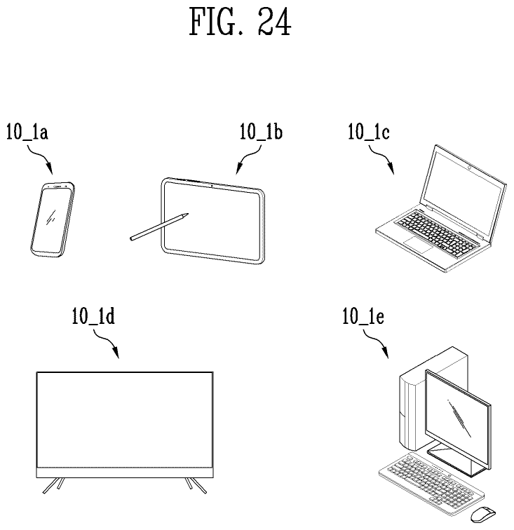

FIGS. 24 to 26 are schematic diagrams of an electronic device according to various embodiments. FIGS. 24 to 26 illustrate examples of various electronic devices to which a display device according to embodiments is applied.

FIG. 24 illustrates a smartphone 10_1a, a tablet PC 10_1b, a laptop 10_1c, a TV 10_1d, and a desk monitor 10_1e as examples of electronic devices.

The smartphone 10_1a may include an input module, such as a touch sensor and a communication module in addition to the display module 11ET. The smartphone 10_1a may process information received through a communication module or other input module to display information through a display module of a display device.

Tablet PC 10_1b, laptop 10_1c, TV 10_1d, and desk monitor 10_1e also include a display module and an input module, similar to smartphone 10_1a, and may further include a communication module in some cases.

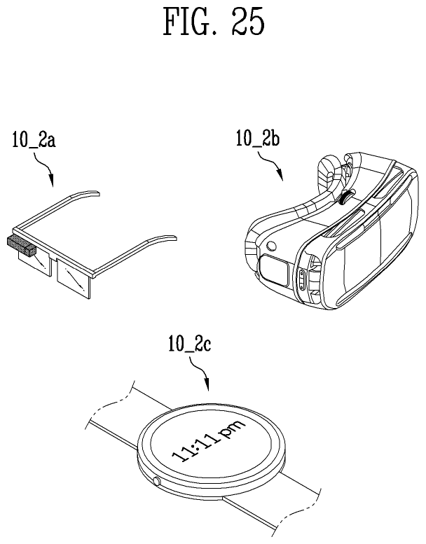

FIG. 25 illustrates a case where an electronic device including a display module is applied to a wearable electronic device. The wearable electronic device may be a smart glasses 10_2a, a head-mounted display 10_2b, a smart watch 10_2c, or the like.

The smart glasses 10_2a and the head-mounted display 10_2b may include a display module that emits a display image, and a reflector that reflects the emitted display image and that provides the display image to the user's eyes, thereby providing a screen of virtual reality or augmented reality to the user.

The smart watch 10_2c includes a biometric sensor as an input device, and may provide biometric information recognized through the biometric sensor to a user through a display module.

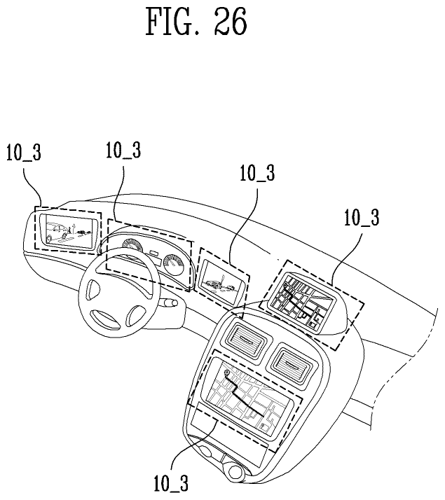

FIG. 26 illustrates a case where an electronic device including a display module is applied to a vehicle. For example, the electronic device 10_3 may be applied to an instrument panel, a center fascia, or the like of a vehicle, or may be applied to a CID (Center Information Display) located on a dashboard of a vehicle, a room mirror display in place of a side mirror, or the like.

Although not shown, the electronic device to which the display device according to embodiments is applied may include not only devices mainly displaying a screen, such as a billboard, an electric signboard, and a game machine, but also various home appliances displaying information through a display module, such as a refrigerator, a washing machine, a dryer, an air conditioner, a robot cleaner, and/or the like. In addition, when the display module has a function of transmitting light, it may be applied to an electronic device, such as a smart window or a transparent display device that displays a background and a display image together. The type of the electronic device according to the embodiments is not limited by the above-described example, and various other electronic devices that are not illustrated may be applied.

The display device and the electronic device according to the present disclosure may maintain high image quality while reducing power consumption.

The drawings and detailed description of the disclosure referred to so far are merely illustrative of the disclosure, which has been used merely for the purpose of describing the disclosure and not for the purpose of limiting the scope of the disclosure as defined in the claims. Therefore, those skilled in the art will appreciate that various modifications and equivalent embodiments are possible therefrom. Therefore, the scope of the present disclosure should be determined by the appended claims, with functional equivalents thereof to be included therein.

What is claimed is:

1. A display device comprising:
a pixel unit comprising pixels connected to data lines;
a data driver configured to selectively apply a data voltage and a park voltage to the data lines;
a voltage provider configured to provide the park voltage; and
a park voltage determiner configured to determine the park voltage based on grayscales for the pixels.

2. The display device of claim 1, wherein the display device is configured to display an image at a first frequency in a first mode, and at a second frequency in a second mode, and
wherein the park voltage comprises a first park voltage to be provided to the data lines in the first mode for a first period.

3. The display device of claim 2, wherein the park voltage comprises a second park voltage to be provided to the data lines in the second mode for a second period.

4. The display device of claim 3, wherein the second frequency is less than the first frequency, and
wherein the second period is longer than the first period.

5. The display device of claim 4, wherein the park voltage determiner comprises a target area setter configured to set a part of the pixel unit as a target area.

6. The display device of claim 5, wherein the park voltage determiner further comprises a first histogram calculator configured to calculate a first histogram of a distribution of data voltages of the target area.

7. The display device of claim 6, wherein the park voltage determiner further comprises:
a representative data voltage calculator configured to calculate a representative data voltage based on weights, the first histogram, and the data voltages of the target area; and
a first park voltage determiner configured to determine the first park voltage based on the representative data voltage.

8. The display device of claim 7, wherein the park voltage determiner further comprises a second histogram calculator configured to calculate a second histogram for a distribution of data voltages of an entire area of the pixel unit.

9. The display device of claim 8, wherein the park voltage determiner further comprises a flicker value calculator configured to calculate second flicker values based on the second histogram and first flicker values.

10. The display device of claim 9, wherein the park voltage determiner further comprises a second park voltage determiner configured to determine the second park voltage based on a minimum value among the second flicker values.

11. An electronic device comprising:
a processor configured to provide image data; and
a display device configured to display an image based on grayscales of the image data, and comprising:
a pixel unit comprising pixels connected to data lines;
a data driver configured to selectively apply a data voltage and a park voltage to the data lines;
a voltage provider configured to provide the park voltage; and
a park voltage determiner configured to determine the park voltage based on the grayscales for the pixels.

12. The electronic device of claim 11, wherein the display device is configured to display the image at a first frequency in a first mode, and at a second frequency in a second mode, and
wherein the park voltage comprises a first park voltage to be provided to the data lines in the first mode for a first period.

13. The electronic device of claim 12, wherein the park voltage comprises a second park voltage to be provided to the data lines in the second mode for a second period.

14. The electronic device of claim 13, wherein the second frequency is less than the first frequency, and
wherein the second period is longer than the first period.

15. The electronic device of claim 14, wherein the park voltage determiner comprises a target area setter configured to set a part of the pixel unit as a target area.

16. The electronic device of claim 15, wherein the park voltage determiner further comprises a first histogram calculator configured to calculate a first histogram of a distribution of data voltages of the target area.

17. The electronic device of claim 16, wherein the park voltage determiner further comprises:
a representative data voltage calculator configured to calculate a representative data voltage based on weights, the first histogram, and the data voltages of the target area; and
a first park voltage determiner configured to determine the first park voltage based on the representative data voltage.

18. The electronic device of claim 17, wherein the park voltage determiner further comprises a second histogram calculator configured to calculate a second histogram for a distribution of data voltages of an entire area of the pixel unit.

19. The electronic device of claim 18, wherein the park voltage determiner further comprises a flicker value calculator configured to calculate second flicker values based on the second histogram and first flicker values.

20. The electronic device of claim 19, wherein the park voltage determiner further comprises a second park voltage determiner configured to determine the second park voltage based on a minimum value among the second flicker values.
